(19) United States
(12) Patent Application Publication
(10) Pub. No.: US 2010/0309453 A1
(43) Pub. Date: Dec. 9, 2010

(54) LASER INSTRUMENT FOR ELECTRO-OPTICAL DISTANCE MEASUREMENT

(75) Inventors: Torsten Gogolla, Schaan (LI); Andreas Winter, Feldkirch (AT); Helmut Seifert, Serba (DE); Gero Schusser, Buergel (DE)

Correspondence Address: CROWELL & MORING LLP;INTELLECTUAL PROPERTY GROUP, P.O. BOX 14300, WASHINGTON, DC, 20044-4300, US

(73) Assignee: Hilti Aktiengesellschaft, Schaan (LI)

(21) Appl. No.: 12/790,693

(22) Filed: May 28, 2010

(30) Foreign Application Priority Data
May 29, 2009 (DE) 10 2009 026 618.6

(51) Int. Cl. G01C 3/08

(52) U.S. Cl. 356/4.01

(57) ABSTRACT

A laser instrument for electro-optical measurement of the distance of a target object to a reference mark is disclosed. The instrument includes a housing, where the housing has an outlet opening to couple out a laser beam from the laser instrument, a measuring device which emits a laser beam and determines a distance value from the receiving beam coming from the target object, a display device to display the distance value, an operating device to operate the laser instrument and to start the distance measurement, and an optical sighting device to align the laser beam on the target object. The direction in which a user looks into the optical sighting device is aligned parallel to the optical axis of the laser beam coupled out of the laser instrument via the outlet opening.

This application claims the priority of German Patent Document No. 10 2009 026 618.6, filed May 29, 2009, the disclosure of which is expressly incorporated by reference herein.

### BACKGROUND AND SUMMARY OF THE INVENTION

The present invention relates to a laser instrument for electro-optical measurement of the distance of a target object to a reference mark comprised of a housing, wherein the housing has an outlet opening to couple out a laser beam from the laser instrument, a measuring device, which emits a laser beam and determines a distance value from the receiving beam coming from the target object, a display device to display the distance value, an operating device to operate the laser instrument and to start a distance measurement, and an optical sighting device to align the laser beam on the target object.

Laser instruments for optical distance measurement are known from the prior art and are marketed commercially. These laser distance meters emit a modulated laser beam, which is aligned on the surface of a target object whose distance from the laser distance meter is being determined. The light of the laser beam reflected or scattered by the surface of the target object, called the receiving beam in the following, is detected by the laser distance meter and used to determine the distance. The field of application of these types of laser distance meters as a rule includes distances of several centimeters to several hundred meters.

The laser distance meters known from the prior art can be divided into two categories in accordance with the arrangement of the transmitting and receiving devices: biaxial arrangements, in which the optical axes of the transmitting and receiving devices run parallel to one another in an offset manner, and coaxial arrangements, in which the optical axes of the transmitting and receiving devices lie on top of one another. The advantage of biaxial arrangements is that beam splitting is not required to separate the emitted laser beam and the receiving beam coming from the target object and that the transmitting and receiving branch can be easily separated from one another, thereby largely avoiding optical crosstalk. However, the disadvantage among other things is that detection problems may arise in the range of short distances due to a parallax. Projection of the target object on the detector surface is displaced, with a diminishing distance, away from the optical axis of the receiving device and also experiences a variation of the beam cross section in the detector plane. The advantage of coaxial arrangements is freedom from parallax and the more cost-effective design. The disadvantage, however, is unavoidable optical crosstalk from the transmitting unit to the receiving unit, because the same optical channel is used for both units. Optical crosstalk produces a cyclical distance measuring error.

In the building and construction industry, laser distance meters are used, among other things, for distance measurement in interior spaces in which the laser beam can also be perceived over large distances (>50 m) with the naked eye. However, with outside use, when aiming at target objects with a high surrounding field luminance, such as, for example, a sunlit wall, the laser beam cannot be seen on the target object very well or at all. Increasing laser power to improve visibility would be conceivable. However, greater laser power is not permissible for safety reasons. The maximum power of a laser distance meter is defined by its laser class. With Class 2 lasers, which include known laser distance meters, a maximum power of 1 mW may not be exceeded. In order to make the position of the laser beam visible to the user on the target object, laser distance meters are equipped with an optical sighting device.

FIG. 1a shows a known laser instrument 1 for electro-optical distance measurement, called a laser distance meter 1 in the following, having a measuring device 2, which aligns the laser beam 3 on a target object 4 and determines a distance value from the light of the laser beam reflected or scattered by the target object 4, which is designated as the receiving beam 5, and having a display device 6 to display the distance value as well as an operating device 7 to operate the laser distance meter 1 and to start the distance measurement. The laser distance meter 1 also has an optical sighting device 8, which is supposed to facilitate distance measurement especially in the case of outside measurements or with poor visibility conditions, when the laser beam 3 is hard to see on the target object 4 with the naked eye or is not visible at all.

The laser distance meter 1 is enclosed by a housing 9. The display and operating devices 6, 7 are embedded in an upper side 10 of the housing 9. In order to guarantee great ease of use when operating the laser distance meter 1 and displaying the distance value, the upper side 10 and the lower side 11 of the housing 9 opposite from the upper side 10 are the two largest housing surfaces of the laser distance meter 1. The front and rear sides 12, 13 adjacent to the upper side 10 as well as the side surfaces 14, 15 of the housing 9 are configured to be as small as possible in order to build a handy laser distance meter 1.

The laser beam 3 exits from the housing 9 via an outlet opening 16, which is arranged on the front side 12 of the housing 9, wherein the optical axis of the laser beam 3 is aligned perpendicular to the front side 12. The receiving beam 5 coming from the target object 4 enters the laser distance meter 1 via an inlet opening 17.

The distance measurement to the target object 4 is carried out with respect to a reference mark located on the laser distance meter. With the known laser distance meter 1, the front side 12, the rear side 13, a limit stop tip 18 or measuring extensions (not shown) are used as reference marks. Switching between the reference marks is carried out by a switching device 19 or automatically, for instance if the limit stop tip 18 is folded out 180°.

FIG. 1b shows a view of the interior of the known laser distance meter 1 from FIG. 1a with the measuring device 2 and the optical sighting device 8. The measuring device 2 includes a transmitting device 20 with a beam source 21 and a first beam-shaping optical system 22, a receiving device 23 with a detector 24 and a second beam-shaping optical system 25 as well as an evaluation device 26. The transmitting and receiving devices 20, 23 are arranged biaxially, i.e., their optical axes run parallel to one another, but do not overlap. The evaluation device 26 is connected via communication connections 27a, 27b, 28 to the detector 24, the beam source 21 and the display device 6. It determines the distance value to the target object 4 from the time difference between the laser beam 3 emitted by the beam source 21 and the receiving beam 5 detected by the detector 24.

The optical sighting device 8 features a first optical element 29 and a second optical element 30. The user looks into the optical sighting device 8 via a sighting viewer 31, which is arranged in the side surface 14 of the housing 9. In doing so, the user looks at the second optical element 30. The ambient light 32 coming from the target object 4 arrives at the optical sighting device 8 with the image of the target object 4 via an inlet opening 33 in the front side 12 and hits the first optical element 29. From there it is deflected in the direction of the second optical element 30. Because the image of the target object 4 is reflected twice, at the first and second optical element 29, 30, an upright, un-reversed image of the target object 4 is produced, which the user perceives in the sighting viewer 31.

Arranged in the optical path of the laser beam 34 that is coupled out of the measuring device 2 is a beam splitter 35, which is preferably inclined at 45° to the optical axis of the laser beam 34. The beam splitter 35 is configured so that the predominant portion of the laser beam (e.g., reflection factor R≧95%) passes through the beam splitter 35 as a transmitted laser beam 36, while the remaining portion (e.g., 5%) is deflected as the reflected laser beam 37. The reflected laser beam 37 penetrates the second optical element 30 of the optical sighting device 8 and can be perceived by the user as a lighter, almost punctiform spot of light. The second optical element 30 is configured in such a way that it is transmittive for the laser wavelength λ and predominantly reflective for the wavelength range of the ambient light being emitted by the target object 4 except for a narrow range around the laser wavelength λ. When the user looks into the optical sighting device 8, he/she sees the image of the target object 4 and the spot of light of the reflected laser beam 37, which is located at the same position in the image of the target object 4 as the laser beam 3 on the surface of the target object 4. By positioning the point of light resulting from the reflected laser beam 37 in the image of the target object 4, the laser beam 3 is positioned precisely on the surface of the target object 4.

FIG. 2 shows another known laser distance meter 40 with a measuring device 41 in a coaxial design and an optical sighting device 42. The measuring device 41 includes a transmitting device 43 with the beam source 21 and a beam-shaping optical system 44, a receiving device 45 with the detector 24 and the beam-shaping optical system 44, the evaluation device 26 as well as a beam splitter 46. The transmitting and receiving devices 43, 45 are arranged coaxially, i.e., their optical axes coincide. The beam-shaping optical system 44 is a shared optical element of the transmitting and receiving devices 43, 45. It is configured in such a way that the laser beam coupled out of the beam source 21 is collimated or focused on the target object 4 and the receiving beam coming from the target object 4 is focused via the beam splitter 46 on the detector 24. The beam splitter 46 is used to help separate the laser beam coupled out of the beam source 21 from the receiving beam, which is reflected or scattered by the target object 4 and is supposed to be detected by the detector 24. The beam splitter 46 is designed in such a way that it is configured to be transmittive for light with wavelength λ and the polarization direction of the laser beam and as reflective for light with a polarization direction perpendicular to the polarization direction of the laser beam.

The optical sighting device 42 is comprised of three optical elements, a first optical element 47, a second optical element 48 and a third optical element 49. The first and third optical elements 47, 49 are configured to be predominantly transmittive for a narrow wavelength range around the laser wavelength λ and configured to be predominantly reflective for other wavelengths of the visible spectral range. The second optical element 48 is configured to be predominantly reflective for all wavelengths of the visible spectral range. The user looks into the optical sighting device 42 via the sighting viewer 31 in the side surface 14 of the housing 9. In doing so, he sees the second optical element 48.

The laser beam 50 coupled out of the measuring device 41 via the beam-shaping optical system 44 passes predominantly (e.g., 95%) through the first optical element 47 and hits the third optical element 49, where the predominant portion (e.g., 95%) passes through as a transmitted laser beam 51 and exits the laser distance meter 40 via an outlet opening 52 in the front side 12, while a small portion (e.g., 5%) is reflected as the reflected laser beam 53 in the direction of the first optical element 47. A small portion (e.g., 5%) of the reflected laser beam 53 is reflected at the first optical element 47 in the direction of the second optical element 48 and from there deflected in the direction of the sighting viewer 31 as the reflected laser beam 54. The user looking into the sighting viewer 31 perceives the laser beam 54 as a sharp point of light.

The ambient light 55 coming from the target object 4 arrives at the laser distance meter 40 as the target object image through the outlet opening 52 and hits the third optical element 49, through which the target object image 55 predominantly passes. The transmitted target object image 56 hits the first optical element 47, is deflected as the reflected target object image 57 in the direction of the second optical element 48 and from there is reflected further as the target object image 58 in the direction of the sighting viewer 31. The user sees the point of light of the reflected-in laser beam together with the target object image and in this way is able to position the laser beam on the target object.

In the case of all known laser distance meters, the outlet opening for the laser beam is arranged in the front side of the housing and the sighting viewer of the optical sighting device in a side surface of the housing so that adjusting the laser beam with the aid of the optical sighting device can be accomplished perpendicular to the optical axis of the laser beam coupled out of the housing “virtually around a corner.” The adjustment around a corner causes problems, above all, for the inexperienced user. The stabilization system of the human eye/brain complex functions especially well if adjustment takes place parallel to the direction of propagation of the outcoupled laser beam. To do so, the sighting viewer in the case of known laser distance meters would have to be arranged in the rear side of the housing. But because other components besides the measuring device are located inside the laser distance meter, it is difficult, for space reasons, to construct an optical path between the sighting viewer of an optical sighting device in the rear side and the outlet opening for the laser beam in the front side.

In contrast, the object of the present invention is to make a laser instrument for electro-optical distance measurement available that permits simple alignment of the laser beam on the target object even for inexperienced users by an optical sighting device.

This object is attained in accordance with the invention with the laser instrument for electro-optical distance measurement cited at the outset in that the direction in which a user looks into the optical sighting device is aligned parallel, preferably coaxially, to the optical axis of the laser beam coupled out of the laser instrument via the outlet opening. With this type of laser distance meter, the user looks in the direction of propagation of the laser beam. The stabilization system of the human eye/brain complex makes simple and precision alignment and positioning of the laser beam on the target object possible.

In a preferred embodiment, the optical sighting device has a sighting viewer, wherein the sighting viewer and the outlet opening are arranged in opposing surfaces of the housing. In doing so, it is especially preferred that the sighting viewer is arranged in the upper side, in the lower side opposite from the upper side or one of the side surfaces of the housing.

In a preferred embodiment, deflection optics are provided, which deflect the laser beam coupled out of the measuring device in the direction of the outlet opening. In the process, the deflection optics are configured to be especially preferably predominantly reflective for a narrow range around the wavelength of the laser beam λ±Δλ, with Δλ=10 μm, and transmittive for other wavelength ranges, in particular for the ambient light coming from the target object.

In a preferred embodiment, the deflection optics simultaneously form a first optical element of the optical sighting device.

In a preferred embodiment, the optical sighting device has a second optical element, which is configured to be predominantly reflective for a narrow range around the wavelength of the laser beam λ±Δλ, with Δλ=10 μm.

It is especially preferred that the second optical element is connected via a communication connection to an evaluation device of the measuring device and makes additional information, for instance in the form of a point of light or the distance value, available to the user in the target object image.

Additional advantages and advantageous embodiments of the subject of the invention can be found in the description and the drawings. Similarly, the characteristics cited in the foregoing and those listed below according to the invention can respectively be used individually or multiply in any combination. The embodiments that are shown and described should not be understood as an exhaustive enumeration, rather they have an exemplary character in describing the invention.

### BRIEF DESCRIPTION OF THE DRAWINGS

FIGS. 1a and 1b show an exterior view (FIG. 1a) and an interior view (FIG. 1b) of a known laser distance meter;

FIG. 2 illustrates another known laser distance meter;

FIG. 3 illustrates a first embodiment of a laser distance meter in accordance with the present invention with an optical sighting device; and

FIG. 4 illustrates a second embodiment of a laser distance meter in accordance with the present invention with an optical sighting device.

### DETAILED DESCRIPTION OF THE DRAWINGS

Unless otherwise indicated, the same or functionally equivalent elements are identified by the same reference numbers in the figures.

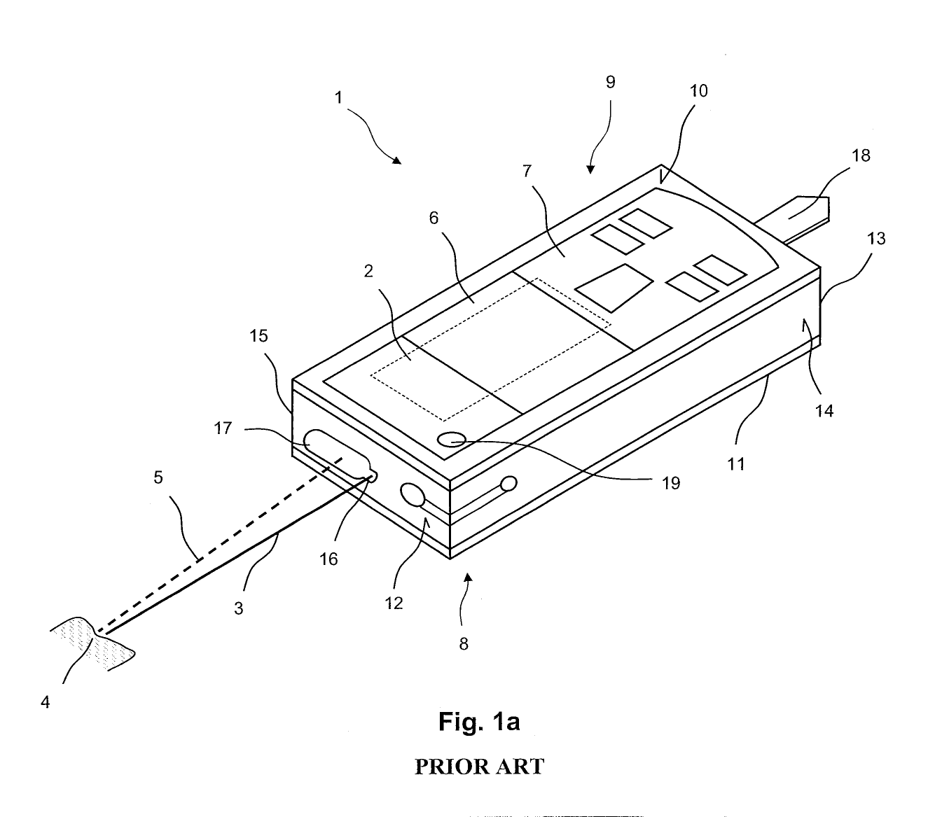

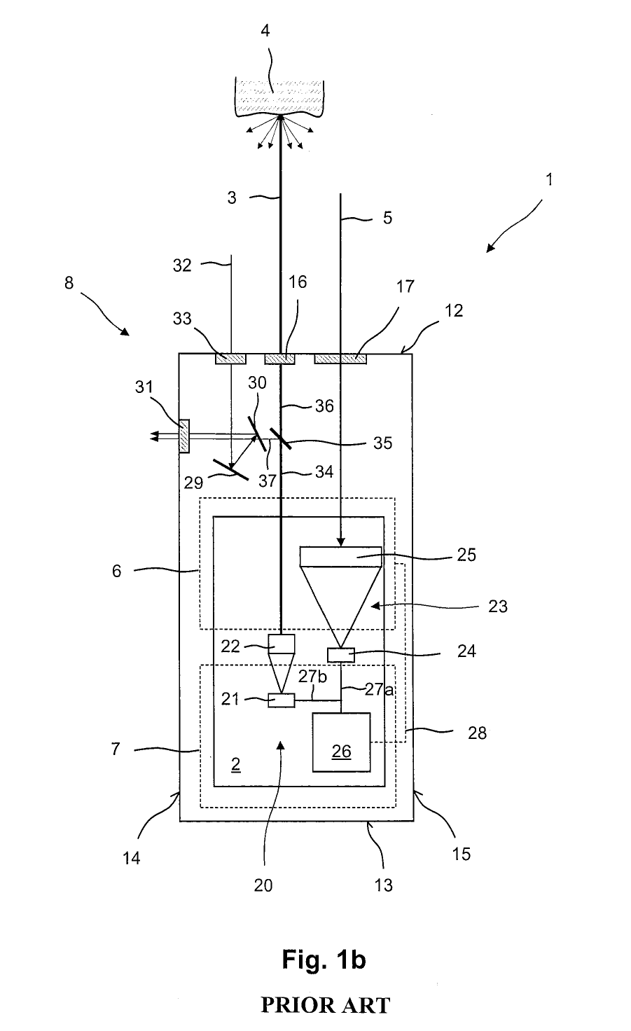

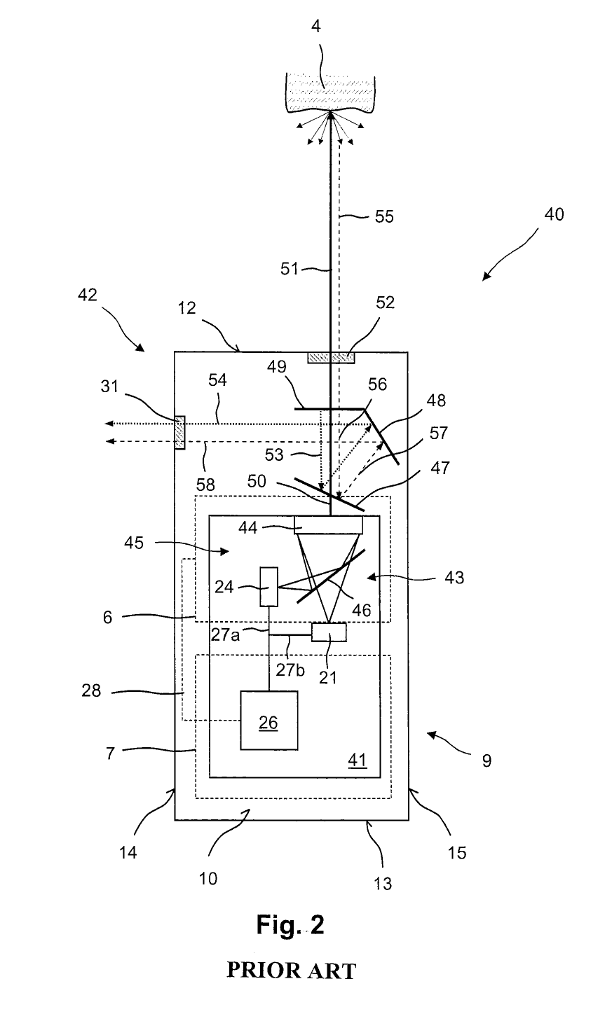

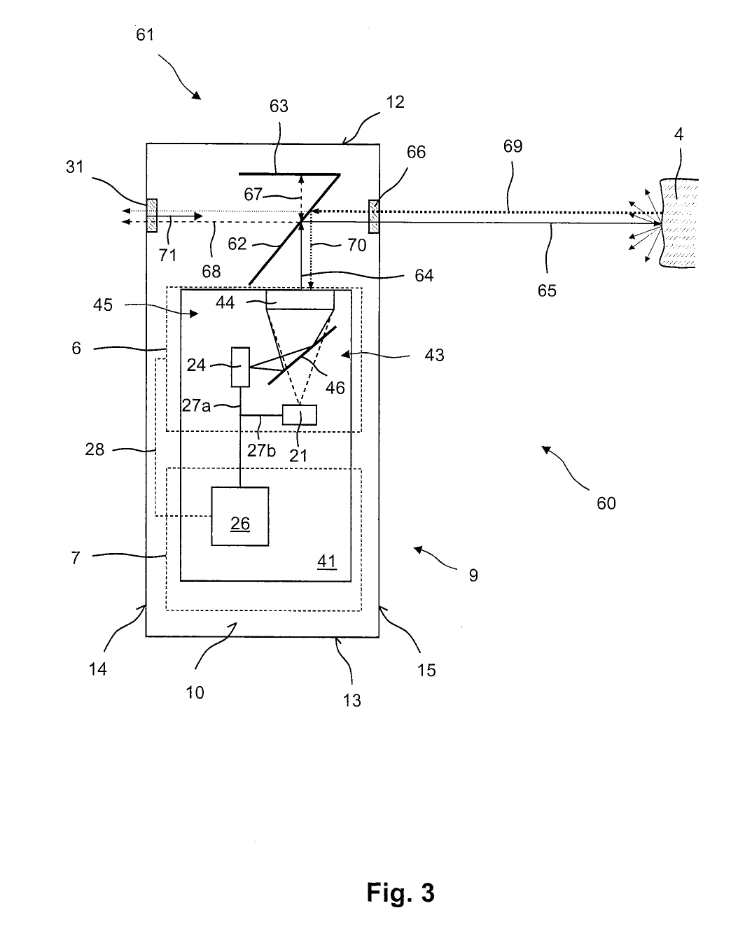

FIG. 3 depicts a first embodiment of a laser distance meter 60 in accordance with the invention for electro-optical measurement of the distance of the target object 4 to a reference mark. In addition to the measuring device 41 in a coaxial design and the display and operating devices 6, 7, the laser distance meter 60 features an optical sighting device 61. The laser distance meter 60 differs from the laser distance meter 1 depicted in FIG. 1a in terms of the design of the optical sighting device 61, otherwise it is constructed analogously.

In addition to the transmitting device 43 with the beam source 21 and the beam-shaping optical system 44, the receiving device 45 with the detector 24 and the beam-shaping optical system 44, the measuring device 41 includes the evaluation device 26 and the beam splitter 46. After exiting the beam source 21, the laser beam hits the beam splitter 46 and then the beam-shaping optical system 44. The beam source 21 is, for example, a semiconductor laser, which generates a laser beam in the visible spectrum, for instance a red laser beam with a wavelength of 635 nm, or another laser with a suitable wavelength and power. The laser beam leaves the beam source 21 at an opening where the laser beam is bent. Because of the bending and divergence, the laser beam expands. In order to restrict the beam diameter of the laser beam to the target object 4, the laser beam is collimated by the beam-shaping optical system 44 or focused on the target object 4. The detector 24 is, for instance, a photo diode or another receiver adjusted to the wavelength and the power of the beam source 21. The receiving beam reflected or scattered by the target object 4 is focused on the detector 24 with the aid of the beam-shaping optical system 44. The evaluation device 26 is connected via the communication connections 27a, 27b to the detector 24 and the beam source 21 and determines the distance value to the target object 4 from the time difference between the laser beam emitted by the beam source and the receiving beam detected by the detector 24. The evaluation device 26 is connected via the communication connection 28 to the display device 6, which displays the measured distance value.

The optical sighting device 61 has a first optical element 62 and a second optical element 63. The user looks into the optical sighting device 61 via the sighting viewer 31 in the side surface 14. In doing so, he sees the first optical element 62. The first optical element 62 is configured as a beam splitter and is arranged in the optical path of the laser beam coupled out of the measuring device 41 at an inclination of 45° to the optical axis.

The laser beam 64 coupled out of the measuring device 41 via the beam-shaping optical system 44 hits the first optical element 62 of the optical sighting device 61, which is configured to be predominantly reflective for the laser wavelength (e.g., reflection factor R≧95%) so that the predominant portion of the laser beam 64 exits the laser distance meter 60 as the reflected laser beam 65 via an outlet opening 66 in the side surface 15 and a small portion passes through the first optical element 62 as the transmitted laser beam 67. The second optical element 63, which is configured to be predominantly reflective for the laser wavelength λ, is arranged in the optical path of the transmitted laser beam 67. The transmitted laser beam 67 is reflected in itself at the second optical element 63 and hits the first optical element 62. There the predominant portion of the laser beam 67 is deflected as the reflected laser beam 68 in the direction of the sighting viewer 31. The reflected laser beam 68 appears to the user as a sharp point of light and indicates to him/her the precise position of the laser beam 65 on the target object 4.

The laser beam 65 exiting from the laser distance meter 60 via the outlet opening 66 hits the target object 4. A portion of the laser beam 65 is reflected at the target object 4 and a portion is scattered diffusely. The reflected laser beam and a portion of the scattered laser beam arrive in the laser distance meter 60 as the receiving beam 69 via the outlet opening 66. The receiving beam 69 hits the first optical element 62, which is configured to be predominantly reflective for a narrow wavelength range ±Δλ around the laser wavelength λ and predominantly transmittive for other wavelengths. At the first optical element 62, the predominant portion of the receiving beam 69 is deflected as the reflected receiving beam 70 in the direction of the beam-shaping optical system 44, hits the beam-shaping optical system 44 and is focused in the direction of the beam splitter 46 and projected via the beam splitter 46 on the detector 24. The ambient light with the target object image passes through the first optical element 62 except for a narrow wavelength range around laser wavelength λ and reaches the user's eye via the sighting viewer 31. The user sees the target object image together with the point of light of the reflected laser beam 68, which is located in the target object image at the same position as the laser beam on the target object 4.

Because the user looks directly into the laser beam 68, the transmittance and reflection factor of the first optical element 62 and the second optical element 63 of the optical sighting device 61 are adjusted in such a way that the power that reaches the user's eye is very heavily attenuated in order to prevent eye damage as well as glare of the target object image. Alternatively, a filter may be used, which weakens the power of the laser beam 68.

The sighting viewer 31 and the outlet opening 66 for the laser beam 65 are arranged on the opposing side surfaces 14, 15 of the housing 9. The direction in which the user looks in the sighting viewer 31 is indicated by a direction vector (arrow 71). The direction 71 in which the user looks into the sighting viewer 31 of the optical sighting device is coaxial to the optical axis of the laser beam coupled out of the laser distance meter 60 via the outlet opening 66. Due to the coaxial arrangement, the user looks in the direction of propagation of the laser beam. The stabilization system of the human eye/brain complex makes simple and precise alignment and positioning of the laser beam on the target object possible.

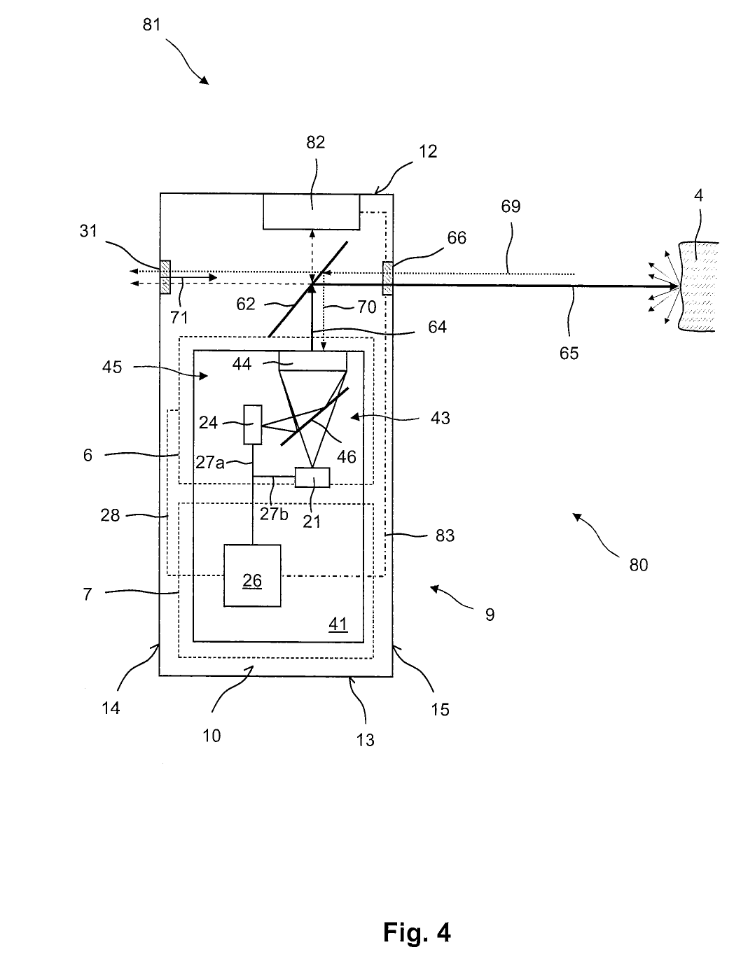

FIG. 4 shows a second embodiment of a laser distance meter 80 in accordance with the invention for electro-optical measurement of the distance of the target object 4 to a reference mark, which differs from the first embodiment 60 of a laser distance meter in accordance with the invention in terms of the design of the optical sighting device 81, otherwise it is constructed analogously.

In addition to the optical sighting device 81, the laser distance meter 80 includes the measuring, display and operating devices 41, 6, 7, which are also contained in the laser distance meter 60. The optical sighting device 81 is composed of two optical elements, the first optical element 62 and a second optical element 82. The first optical element 62 is configured as a beam splitter with a high reflection factor (e.g., R≧95%) for the laser wavelength λ, and a high transmittance for all other wavelengths of the visible spectrum

The predominant portion of the laser beam 64 coupled out of the measuring device 41 via the beam-shaping optical system 44 is deflected at the first optical element 62 as the reflected laser beam 65 in the direction of target object 4. The receiving beam 69 hits the first optical element 62, where the predominant portion of the receiving beam 69 is deflected as the reflected receiving beam 70 in the direction of the measuring device 41. As described for the laser distance meter 60, the image of the target object 4 reaches the user's eye via the first optical element 62. In addition, the second optical element 82 generates a field distribution, which is reflected via the first optical element 62 in the direction of the sighting viewer 31. The user perceives this field distribution, on the one hand, as a sharp point of light, which is located at the same position in the image of the target object 4 as the laser beam on the target object 4 so that it is possible to position the laser beam precisely on the target object 4. On the other hand, the user sees additional information through this field distribution such as, for example, the measured value of distance in target object image. The second optical element 82 is connected via a communication connection 83 to the evaluation device 26 of the measuring device 41.

The second optical element 82 of the optical sighting device 81 is comprised of a micro-display, whose display is transformed to infinity via a lens. This transformed image is perceived by the user as the content of the display.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A laser instrument for electro-optical measurement of a distance of a target object to a reference mark, comprising:
a housing, wherein the housing has an outlet opening to couple out a laser beam from the laser instrument;
a measuring device, which emits the laser beam and determines a distance value from a receiving beam coming from the target object;
a display device to display the distance value;
an operating device to operate the laser instrument and to start a distance measurement; and
an optical sighting device to align the laser beam on the target object;
wherein a direction in which a user looks into the optical sighting device is aligned parallel to an optical axis of the laser beam coupled out of the housing via the outlet opening.

2. The laser instrument according to claim 1, wherein the direction in which the user looks into the optical sighting device is aligned coaxially to the optical axis of the laser beam coupled out of the housing.

3. The laser instrument according to claim 1, wherein the optical sighting device has a sighting viewer, wherein the sighting viewer and the outlet opening are arranged in opposing surfaces of the housing.

4. The laser instrument according to claim 3, wherein the sighting viewer is arranged in an upper side, in a lower side opposite from the upper side, or in a side surface of the housing.

5. The laser instrument according claim 1, further comprising deflection optics which deflect the laser beam emitted from the measuring device in a direction of the outlet opening.

6. The laser instrument according to claim 5, wherein the deflection optics are predominantly reflective for a narrow range around a wavelength of the laser beam λ±Δλ, where Δλ=10 μm, and transmittive for other wavelength ranges.

7. The laser instrument according to claim 5, wherein the deflection optics form a first optical element of the optical sighting device.

8. The laser instrument according to claim 7, wherein the optical sighting device has a second optical element which is predominantly reflective for a narrow range around the wavelength of the laser beam λ±Δλ, where Δλ=10 μm.

9. The laser instrument according to claim 8, wherein the second optical element is connected via a communication connection to an evaluation device of the measuring device and makes information available to the user in a target object image.

10. The laser instrument according to claim 9, wherein the information represents a point of light.

11. The laser instrument according to claim 9, wherein the information represent a distance value.
